(19) United States
(12) Patent Application Publication
(10) Pub. No.: US 2018/0361950 A1
(43) Pub. Date: Dec. 20, 2018

(54) TAPE-REINFORCED PLASTICS CLADDING PART AND PROCESS FOR THE MANUFACTURE THEREOF

(71) Applicant: FORD GLOBAL TECHNOLOGIES, LLC, Dearborn, MI (US)

(72) Inventors: Thomas Baranowski, Würselen (DE); Maik Broda, Würselen (DE)

(21) Appl. No.: 16/008,272

(22) Filed: Jun. 14, 2018

(30) Foreign Application Priority Data
Jun. 14, 2017 (DE) 102017210047.8

(51) Int. Cl. B60R 13/02; B60R 13/04; F16B 21/06; F16B 5/06

(52) U.S. Cl. CPC B60R 13/0206; B60R 13/04; B32B 15/01; F16B 5/0692; F16B 21/065

(57) ABSTRACT

A plastics cladding part for a motor vehicle includes a support component which has a fastening side facing toward a body of the motor vehicle and a visible side facing away from the body, and at least one clip housing. The clip housing is configured integral with the support component on the fastening side thereof for the reception of a fastening clip. The clip housing and the support component are mechanically stiffened with a reinforcing tape. An injection molding process is also described for the manufacture of the tape-reinforced plastics cladding part.

### TECHNICAL FIELD

This document relates to a plastics cladding part for a motor vehicle comprising a support component and at least one clip housing as well as to a process for the manufacture of a plastics cladding part for a motor vehicle.

### BACKGROUND

Internal and external cladding parts for motor vehicles are well known from the prior art. The cladding parts, in particular visible parts or trim parts or trim strips, usually consist of a thermoplastic plastic and are manufactured in an injection molding process as so-called moldings. The plastics cladding parts have a support component having an outer, a so-called visible side, and an inner fastening side. The visible side is typically configured with a visually attractive appearance as a Class A surface. The fastening side can have different fastening elements, which serve to connect the cladding part to the body. For instance, a plastics cladding part can be connected by means of a fastening clip, which can be made of metal or plastic, to the body of the motor vehicle. To this end, the plastics cladding part can be configured integral, that is to say in one piece, with the fastening clip. Alternatively, the support component can be configured, on the fastening side, integral with a clip housing. The fastening clip is then latched or snapped in place, as an additional component, in the clip housing. Generally, support component and fastening elements are manufactured in one cycle in an injection molding process.

A crucial problem in the injection molding process in the manufacture of complex multidimensional structures is the emergence of so-called sink marks, which appear to the observer as dents or indentations on the surface of the plastics parts. Sink marks are formed usually at the point of intersection or point of attachment of two walls having different wall thicknesses. In particular, they arise in increased measure when greater material accumulations, due to thicker wall thicknesses in the transition region, are produced. Sink marks are formed by volume contraction of the plastics melt during cooling. The mass of the hot plastic assumes a greater volume than that of the cooled plastic. At the same time, the solidified surface layer is not yet stable enough to absorb the internal volume contraction forces.

Precisely this problem can arise at the transition or at the point of attachment of the side walls of the clip housing and the mostly planar support component and leads to sink marks on the visible side, whereby the surface quality of the corresponding cladding part no longer meets the requirements of a Class A surface. This can be avoided, on the one hand, in that the wall thickness of the support component lies within a range between 3 and 4 mm, so that sink marks which are formed by the walls of a clip housing are no longer discernible on the surface of the visible side. On the other hand, clip housings are configured to receive fastening clips having a reduced wall thickness in the transition region to the support component. At the same time, however, the necessary mechanical stability of the housing must remain guaranteed, for which reason the wall thickness rises with increasing distance from the surface of the fastening side of the support component. In addition, stiffening ribs, which connect the side walls of the clip housing to the support component, are provided.

For instance, U.S. Pat. No. 9,302,631 discloses an automobile cladding part, which is connected to a safety clip in order to be fastened to a vehicle body, in particular to a vehicle door leaf. For the connection to the automobile cladding part, mechanical fastenings or clip connections can be used, in particular the clip has recesses into which the automobile cladding part can be snapped. A receiving housing is also attached to the vehicle body in order to form a snap connection with the safety clip. In order to ensure sufficient mechanical stability of the snap connections, it is necessary to produce the individual connecting elements with a high wall thickness.

From U.S. Pat. No. 6,681,543 is known an injection molded cladding part for vehicles, which is likewise connected to the vehicle body by means of a clip. In order to be able to manufacture the cladding part with a smallest possible wall thickness, it is additionally fixed to the clip connection with a double-sided adhesive tape. The necessary mechanical stability is attained by three reinforcing ribs, which are disposed between cladding part and vehicle body.

US 2016/0280128 A1 discloses an internal cladding part for motor vehicles which comprises a transparent support component, the front side of which is covered with a transparent cover material. The cover material is connected, for instance by means of a transparent, double-sided adhesive tape, to the front side of the support component, whereby usage of mechanical fastening means, such as clip connections, can be avoided.

In US 2007/0085361 A1 too, the use of mechanical fastening means, in particular clip connections, is intended to be dispensed with. Disclosed is an elongate injection molded external cladding part for motor vehicles, consisting of a cladding part and a support element. External cladding parts of this type are usually fastened to the vehicle body with double-sided adhesive tape, which is adhered to the inner side of the support element. For the fastening of the adhesive tape, appropriate portions of the support element are constructed with increased wall thickness. In manufacture using the injection molding process, this likewise leads, however, to the previously described sink marks on the visible side of the cladding part. A remedy is intended to be provided by a decorative cladding part, which is articulately connected to the support element and is brought into coincidence with this by pivoting. The support element and the decorative cladding part can be fixed one to the other, for instance, by a mechanical snap connection or by means of adhesive tape. In this way, the wall thickness of the injection molded external cladding part can be reduced to, say, 2-2.5 mm.

A casting process for the manufacture of a vehicle cladding part which is intended to be fastened to a vehicle body by means of adhesive tape is known from U.S. Pat. No. 5,328,731. In this, liquid plastic is introduced into a mold and cured by the influence of heat. For the fastening of the cladding part to the vehicle body by means of adhesive tape, it is necessary to protect the adhesive tape by a barrier, in particular a hard-plastic strip, from the plasticizers contained in the plastic of the plastics cladding part. For the formation of a second layer, the hard-plastic strip, after the curing of the vehicle cladding part, is connected to the latter.

From the prior art, reinforcing tapes which are used also in connection with injection molding processes, for instance in so-called overmolding, back-molding or insert molding processes, in order to locally increase the rigidity of the plastics molding, are additionally known. These tapes comprise a polymer matrix in which, for example, unidirectionally oriented reinforcing fibers are disposed.

### SUMMARY

Against this background, the object of this document is to provide a plastics cladding part having low material expenditure and weight, along with simultaneously high mechanical stability and surface quality, and to define a process for the manufacture thereof.

This object is achieved by a plastics cladding part and an injection molding process having the features of the following claims.

It should be pointed out that the features and measures individually cited in the following description can be mutually combined in any chosen, technically sensible manner and reveal further embodiments of the plastics cladding part and method. In addition, the description characterizes and specifies the plastics cladding part and method, in particular in association with the figures.

What is proposed is a plastics cladding part for a motor vehicle of the type described in the introduction, in particular a visible part, a trim part or a protective strip. Such a plastics cladding part can be, for instance, a cover of a glove compartment box belonging to the motor vehicle interior, or perhaps a side protection strip for the outer side of an automobile door. The plastics cladding part is thus often of planar construction and has a likewise mostly planar support component, which has a fastening side facing toward a body of the motor vehicle and a visible side facing away from the body of the motor vehicle. In order to connect the plastics cladding part to the body, fastening elements are provided on the fastening side of the support component. At least one clip housing is connected integrally, that is to say in one piece, to the support component. The clip housing is configured for the reception of, in particular for snap-locking to, a separate fastening clip. To this end, the clip housing has walls which fixingly embrace the fastening clip.

Both the clip housing and the support component are mechanically stiffened with a reinforcing tape. To this end, the reinforcing tape runs along the fastening side of the support component and follows the integrally, usually at right angles, connected side walls of the clip housing. Preferably, the reinforcing tape is mechanically and/or physically fixedly connected to the plastic of the cladding part or integrated therein, and/or enclosed by the plastic. The walls of the clip housing, which walls are mechanically stiffened by means of the reinforcing tape, can be constructed with uniform, reduced wall thickness. Through the use of the reinforcing tape, material savings can therefore be made in the manufacture of the plastics cladding parts, without impairing the mechanical stability of the clip housing. Also additional stiffening ribs, as are customary in the prior art, can be dispensed with through the use of a reinforcing tape, which results in further material savings and weight reduction.

For the stiffening of the clip housing and of the support component, a single, continuous reinforcing tape can be used. Preferably, a plurality of reinforcing tapes are used, which are arranged separate from one another and, through their cooperation, locally stiffen selected walls of the plastics cladding part. The use of a first and a second reinforcing tape, which are respectively connected both to the fastening side of the support component and to lateral or top walls of the clip housing, is particularly preferred. It is advantageous if the reinforcing tapes are arranged at a distance apart in an upper receiving region, configured to receive the clip housing, of the fastening clip.

For the integration into the polymer matrix of the plastics cladding part, the reinforcing tape, in a preferred embodiment of the invention, has a first polymer, the structure of which resembles the structure of a second polymer of the clip housing. During the manufacture, the first and the second polymer fuse at least partially together, so that a physical connection between the polymer matrix of the reinforcing tape and the polymer matrix of the plastics cladding part is formed. Particularly advantageously, the first and the second polymer have the same structure.

Due to the possibility of constructing the clip housing with a lesser wall thickness, in a preferred embodiment the wall thickness of the side walls of the clip housing and the wall thickness of the support component is identical. The formation of sink marks is thereby prevented, which leads to a considerable enhancement of the surface quality of the visible side. The visible face of the plastics cladding part can therefore be constructed as a Class A surface.

The plastics cladding part, in particular the clip housing and the support component, can comprise various plastics, such as, for instance, polypropylene, polyamide (respectively without or with fillers, such as talcum, chalk, short or long fibers, for example glass fibers, etc.), polioxymethylene, or polycarbonate/acrylonitrile-butadiene-styrene (PC/ABS). Furthermore, the plastics cladding part can be constituted by a physically or chemically foamed molding consisting of the aforementioned materials. The reinforcing tape can be constructed as a unidirectional tape (UD-tape), as a biaxial tape, or as a multiaxial tape, and/or comprise a plurality of layers and combinations of these tape types. The reinforcing tape can be reinforced with glass fibers, carbon fibers, aramid fibers or other (in particular natural) fibers.

In accordance with an additional aspect, a process, in particular an injection molding process, is provided for the manufacture of a tape-reinforced plastics cladding part for a motor vehicle. The plastics cladding part has a support component and a clip housing for the reception of a fastening clip and is manufactured by means of the below-described steps:

Firstly a tool, preferredly an injection molding tool having at least one first mold portion, which is provided for the formation of the support component, and having a second mold portion, which is provided for the formation of the clip housing, is provided. The mold portions are configured, in a manner which is known per se, as a negative to the support component or to the clip housing, in order to manufacture the plastics cladding part integrally, i.e. in one piece. In order to gain access to the inside of the injection molding tool, this is opened. After this, a single, continuous reinforcing tape or a plurality of reinforcing tapes are arranged and fixed at stiffening positions within the tool, in particular the injection molding tool. The stiffening positions are found both in the first and in the second mold portion and correspond to those walls or regions of the plastics cladding part which are intended to be stiffened by means of the reinforcing tape. After or during the fixing of the one reinforcing tape or the plurality of reinforcing tapes, the tool, in particular the injection molding tool, is closed in the usual manner.

The reinforcing tapes disposed within the tool, in particular the injection molding tool, are overmolded or back-molded or insert molded by filling of the tool, in particular the injection molding tool, in likewise known manner with a thermoplastic, and preferredly injection-moldable, plastics melt. To this end, the thermoplastic plastic is brought by heating into a liquid, molten state of aggregation. As soon as the hot plastics melt comes into contact with the one or more reinforcing tapes, a fusion of the two plastics takes place. Preferably, the polymer matrix or the structure of the polymer of the reinforcing tape is identical with the polymer matrix or the structure of the polymer of the plastics melt, so that these are able to be fused together. After the curing or cooling of the plastics melt, the tool, in particular the injection molding tool, can be opened, and the ready, tape-reinforced plastics cladding part removed. The reinforcing tape is fused with or physically connected to the polymer matrix of the plastics cladding part.

In a preferred process variant, the one or more reinforcing tapes are respectively arranged within the first and the second mold portion. Because a continuous reinforcing tape is disposed both on a wall of the clip housing and on a wall of the support element, or stiffens these, the generally right-angled transition between clip housing and support component is additionally reinforced. This is particularly sensible, since increased forces act specifically on this transition region.

According to an alternative variant of the process, the preferredly injection-moldable plastic, during the process, in particular during the injection molding process, is chemically or physically foamed. In chemical foaming, to the plastic are added chemical substances which lead to a build-up of gas, and thus to the formation of bubbles, within the plastics melt. In physical foaming, in addition to the plastics melt, gas is passed into the tool, in particular the injection molding tool, which gas likewise leads to the formation of bubbles. After the curing, a foamed molding is respectively formed.

### BRIEF DESCRIPTION OF THE DRAWING FIGURES

Further advantageous embodiments of the invention are disclosed in the following description of the figures, wherein:

FIG. 1 shows a plastics cladding part, as known from the prior art, in a perspective view.

FIG. 2 shows a clip housing of the plastics cladding part according to FIG. 1 in a perspective view.

FIG. 3 shows a perspective view of a fastening clip according to the prior art.

FIG. 4 shows an exemplary embodiment of a new and improved plastics cladding part incorporating a new and improved clip housing.

FIG. 5 shows in detail a clip housing of the new and improved plastics cladding part illustrated in FIG. 4.

FIG. 6 shows a flow chart of an injection molding process for the manufacture of the new and improved plastics cladding part illustrated in FIG. 4.

### DETAILED DESCRIPTION

In the different figures, same parts are always provided with the same reference symbols, for which reason these are generally also only described once.

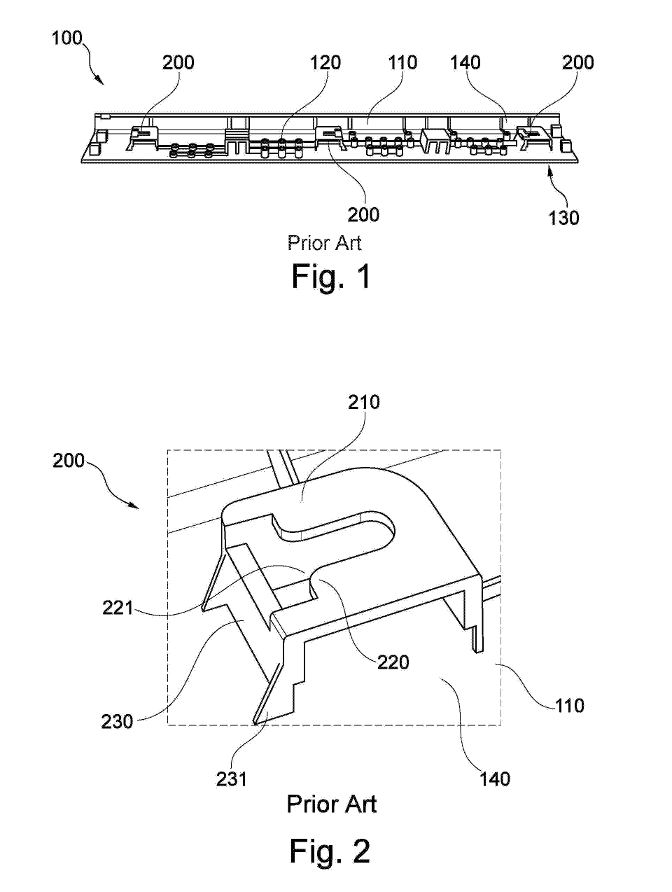

In FIG. 1, a plastics cladding part 100 as known from the prior art, comprising a support component 110 and various fastening elements 120, is represented in a perspective view. The support component 110 has a visible side 130 (not evident in the representation) and a fastening side 140. In the installed state, the fastening side 140 faces in the direction of a motor vehicle body, whereas the visible side 130 in the interior of the vehicle or on the exterior of the vehicle, apparent to the observer, faces away from the motor vehicle body. On the fastening side 140, three clip housings 200 are arranged integral with the support component 110.

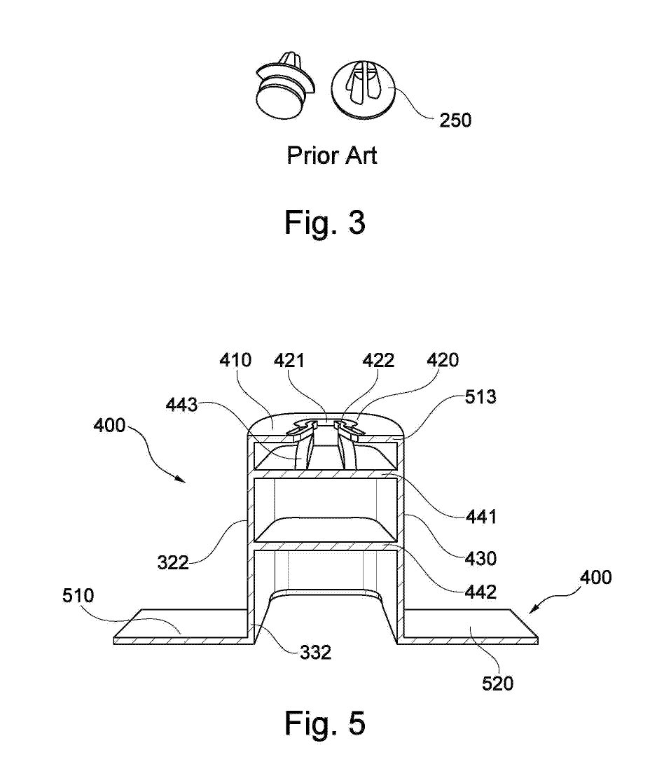

From FIG. 2, the clip housing 200 according to FIG. 1 can be seen in enlarged representation. The clip housing 200 is constructed in a manner which is known per se and has a top wall 210 having a receptacle or mounting 220 for a fastening clip 250 (see FIG. 3), and side walls 230, which project at right angles from the fastening side 140 of the support component 110. The receptacle 220 is disposed roughly centrally within the top wall 210 and has a receiving opening 221, into which the fastening clip 250 (see FIG. 3) can be introduced such that this is fixed or detained by the receptacle 220. To ensure that no sink marks are formed on the visible side 130 of the support component 110, the side walls 230 of the clip housing 200, along their connection to the support component 110, are constructed with reduced wall thickness. Since particularly high forces act on the connection between clip housing 200 and support component 110, along the side walls 230 are configured stiffening ribs 231, which are connected both to the clip housing 200 and to the support component 110. In FIG. 3, a well-known fastening clip 250, as is usually used in the prior art, is represented in perspective view.

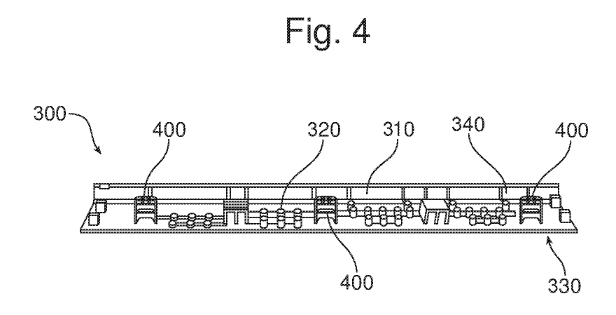

FIG. 4 illustrates the new and improved plastics cladding part 300, having a support component 310 and various fastening elements 320. The support component 310 has a visible side 330 (not evident in the representation) and a fastening side 340. In the installed state, the fastening side 340 faces in the direction of the motor vehicle body, whereas the visible side 330 in the interior of the vehicle or on the exterior of the vehicle, apparent to the observer, faces away from the motor vehicle body. On the fastening side 340, three clip housings 400 are arranged integral with the support component 310.

FIG. 5 represents schematically an exemplary embodiment of a new and improved clip housing 400 for the new and improved plastics cladding part 300 according to this document, having a first reinforcing tape 510 and a second reinforcing tape 520. The clip housing 400, which is formed by the top wall 410 and the side walls 430, has within the receiving opening 421 clamping jaws 422, which are configured as a snap-action mechanism for the fixing of the fastening clip 250 (see FIG. 3). The side walls 430 are constructed with constant wall thickness. The wall thickness corresponds to the reduced wall thickness, as known from the prior art. Within the clip housing 400 are disposed, connected at right angles to the side walls 430, a first transverse web 441 and a second transverse web 442 for the inner stiffening of the clip housing 400. The first transverse web 441 has guide rails 443, which facilitate the reception and introduction of a fastening clip 250 (see FIG. 3). The first reinforcing tape 510 and the second reinforcing tape 520 run respectively along the fastening side 340 of the support component 310, along one of the side walls 430 and along an outer region of the top wall 410 of the clip housing 400. By virtue of the high flexibility of the reinforcing tapes 510, 520, these can exactly follow the course of the walls and be fitted into the angles present in the transition region, for instance between the fastening side 340 of the support component 310 and one of the side walls 430.

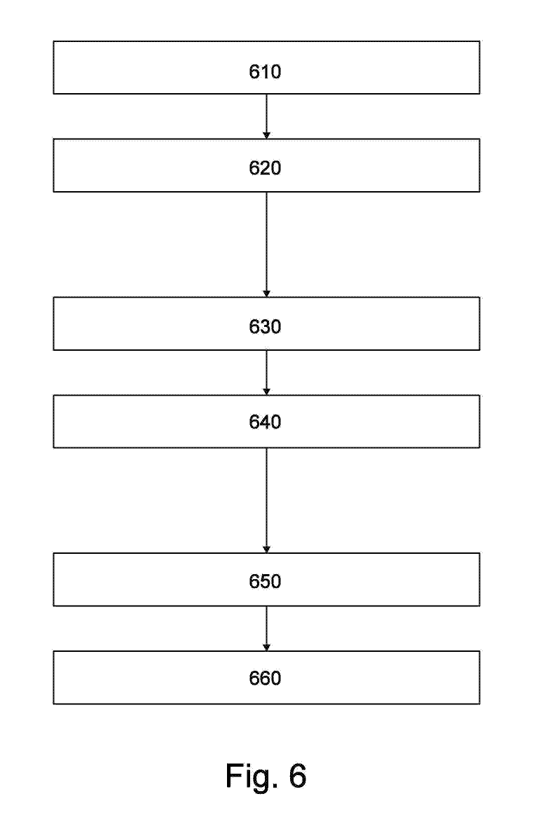

FIG. 6 shows a flow chart of a process, in particular an injection molding process, for the manufacture of a tape-reinforced plastics cladding part 300 for motor vehicles.

In a first process step 610 (provision and opening of an injection molding tool), an injection molding tool having at least one first mold portion and a second mold portion is provided. The first mold portion serves for the formation of the support component 310, and the second mold portion for the formation of the clip housing 400. Further mold portions can be provided, for instance for the formation of additional fastening elements 320. The first and the second mold portion are connected to each other in order to manufacture the plastics cladding part 300 integrally. The mold portions are constructed, in a manner which is known per se, as a negative to the shape to be formed. Usually an injection molding tool comprises two halves, wherein one of the halves is moved away from the other for opening purposes.

In a second process step 620 (arrangement and fixing of reinforcing tapes within the injection molding tool), two reinforcing tapes 510, 520 are inserted into the injection molding tool. The reinforcing tapes 510, 520 are fixed at stiffening positions. The stiffening positions correspond to the walls 410, 430 or portions of the plastics cladding part 300, which are intended to be stiffened by means of the reinforcing tapes 510, 520. The reinforcing tapes 510, 520 are placed within the corresponding mold portions, wherein a reinforcing tape 510, 520 is preferably arranged running both along the first mold portion and along the second mold portion.

In a third process step 630, the injection molding tool is closed.

During a fourth process step 640 (overmolding of the reinforcing tapes with thermoplastic plastic), the reinforcing tapes 510, 520 which are present within the closed injection molding tool are overmolded with a thermoplastic plastic. Depending on the way in which the reinforcing tapes 510, 520 are arranged within the injection molding tool, these can at the same time, or alternatively, also be insert molded or back-molded. For the actual injection molding operation, a thermoplastic plastic, which is usually present as a granulate, is heated and melted. By means of a nozzle, the plastics melt is injected, preferably under high pressure, into the injection molding tool or the cavities of the mold portions. If the hot plastics melt comes into contact with the reinforcing tapes 510, 520, the polymer matrix thereof at least partially melts. Preferably, the reinforcing tapes 510, 520 and the thermoplastic plastic have a similar or identical polymer matrix, so that a fusion, or even a welding together, of the two materials takes place. In this way, a strong physical connection between the reinforcing tapes 510, 520 and the clip housing 400 or the support component 310 of the plastics cladding part 300 is able to be created. Alternatively, the plastics melt within the injection molding tool can be foamed chemically, by the addition of a gas-forming substance, and/or physically, by gas feed.

A curing of the thermoplastic plastic takes place in a fifth process step 650. To this end, the plastics melt is cooled until it solidifies. During the cooling, the volume contraction described in the introduction materializes, which can have an adverse effect on the surface quality, for instance through the formation of sink marks. In order to avoid sink marks, the clip housing 400 and the support component 310 are manufactured with preferably uniform, or at least similar, wall thickness. According to a sixth process step 660, the so-called demolding, the injection molding tool is opened and the cured, tape-reinforced plastics cladding part 300 is removed or ejected.

What is claimed:

1. A plastics cladding part for a motor vehicle, comprising a support component, having a fastening side oriented toward a body of the motor vehicle and a visible side facing away from the body, and at least one clip housing, said clip housing being configured integral with the support component on the fastening side thereof for reception of a fastening clip, and wherein the clip housing and the support component are mechanically stiffened with a reinforcing tape.

2. The plastics cladding part as claimed in claim 1, wherein said reinforcing tape includes at least one first reinforcing tape and a second, separate reinforcing tape being respectively connected to walls of the plastics cladding part in order to locally stiffen said walls.

3. The plastics cladding part as claimed in claim 1, wherein a first polymer of the reinforcing tape is fused with a second polymer of the clip housing.

4. The plastics cladding part as claimed in claim 3, wherein side walls of the clip housing and the support component are of equal thickness.

5. The plastics cladding part as claimed in claim 4, wherein the visible side is an A Class surface.

6. The plastics cladding part as claimed in claim 1 wherein a first polymer of the reinforcing tape is fused with a second polymer of the support component.

7. The plastics cladding part as claimed in claim 1 wherein a first polymer of the reinforcing tape is fused with a second polymer of the clip housing and the support component.

8. An injection molding process for manufacture of a tape-reinforced plastics cladding part for a motor vehicle, having a support component and a clip housing for reception of a fastening clip, comprising:
opening of injection molding tool having at least one first mold portion for the support component and a second mold portion for the clip housing in order to integrally form the tape-reinforced plastics cladding part;
fixing of one or more reinforcing tapes at stiffening positions within the injection molding tool;
closing of the injection molding tool;
overmolding of the one or more reinforcing tapes, wherein the injection molding tool is filled with a thermoplastic plastic and the thermoplastic plastic is fused with the one or more reinforcing tapes;
curing of the thermoplastic plastic; and
opening of the injection molding tool and removing of the tape-reinforced plastics cladding part.

9. The injection molding process as claimed in claim 8, including arranging a continuous reinforcing tape within the first mold portion and the second mold portion.

10. The injection molding process as claimed in claim 9, including chemically foaming the thermoplastic plastic during the injection molding process.

11. The injection molding process as claimed in claim 9, including physically foaming the thermoplastic plastic during the injection molding process.

12. The injection molding process as claimed in claim 9, including chemically and physically foaming the thermoplastic plastic during the injection molding process.
